(19) United States
(12) Patent Application Publication
(10) Pub. No.: US 2023/0333650 A1
(43) Pub. Date: Oct. 19, 2023

(54) Gesture Tutorial for a Finger-Wearable Device

(71) Applicant: Apple Inc., Cupertino, CA (US)

(72) Inventors: Benjamin Hylak, San Francisco, CA (US); Aaron M. Burns, Sunnyvale, CA (US); Adam G. Poulos, Saratoga, CA (US); Arun Rakesh Yoganandan, San Francisco, CA (US); Benjamin R. Blachnitzky, San Francisco, CA (US); Nicolai Georg, San Francisco, CA (US)

(21) Appl. No.: 18/114,629

(22) Filed: Feb. 27, 2023

Related U.S. Application Data
(63) Continuation of application No. PCT/US21/43193, filed on Jul. 26, 2021.
(60) Provisional application No. 63/071,973, filed on Aug. 28, 2020.

(51) Int. Cl. G06F 3/01; G06F 9/451

(52) U.S. Cl. CPC G06F 3/014; G06F 3/017; G06F 9/453

(57) ABSTRACT

A method is performed at an electronic device with one or more processors, a non-transitory memory, a display, and a communication interface provided to communicate with a finger-wearable device. The method includes displaying first instructional content that is associated with a first gesture. The first instructional content includes a first object. The method includes determining an engagement score that characterizes a level of user engagement with respect to the first object. The method includes obtaining finger manipulation data from the finger-wearable device via the communication interface. The method includes determining that the finger-wearable device performs the first gesture based on a function of the finger manipulation data. The method includes, in response to determining that the finger-wearable device performs the first gesture, in accordance with a determination that the engagement score satisfies an engagement criterion, displaying an indication indicating that the first gesture is directed to the first object.

### CROSS-REFERENCE TO RELATED APPLICATIONS

This application is a continuation of Intl. Patent App. No. PCT/US2021/43193, filed on Jul. 26, 2021, which claims priority to U.S. Provisional Patent App. No. 63/071,973, filed on Aug. 28, 2020, which are incorporated by reference in their entirety.

### TECHNICAL FIELD

The present disclosure relates to displaying computer-generated content, and, in particular, displaying a gesture tutorial.

### BACKGROUND

An electronic device may be communicatively coupled with a secondary device. Based on data from the secondary device, the electronic device may manipulate a computer-generated object. However, the secondary device provides a limited amount of control, such as via a preset number of control buttons. Accordingly, the electronic device has a correspondingly limited ability to manipulate the computer-generated object based on data from the secondary device, resulting in a degraded user experience.

Additionally, the efficiency of object manipulation is based on the level of proficiency of a user operating the secondary device. Without adequate instruction, the user provides multiple control inputs to the secondary device in order to perform a single successful (e.g., intended) object manipulation operation. Accordingly, the electronic device utilizes excessive resources in order to obtain and process data associated with the unsuccessful control inputs.

### SUMMARY

In accordance with some implementations, a method is performed at an electronic device with one or more processors, a non-transitory memory, a display, and a communication interface provided to communicate with a finger-wearable device. The method includes displaying, on the display, first instructional content that is associated with a first gesture. The first instructional content includes a first object. The method includes obtaining finger manipulation data from the finger-wearable device via the communication interface. The method includes determining an engagement score that characterizes a level of user engagement with respect to the first object. The method includes determining that the finger-wearable device performs the first gesture based on a function of the finger manipulation data. The method includes, in response to determining that the finger-wearable device performs the first gesture, in accordance with a determination that the engagement score satisfies an engagement criterion, displaying, on the display, an indication indicating that the first gesture is directed to the first object.

In accordance with some implementations, an electronic device includes one or more processors, a non-transitory memory, a display, and a communication interface provided to communicate with a finger-wearable device. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of an electronic device, cause the device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is a block diagram of an example of a finger-wearable device in accordance with some implementations.

FIGS. 3A-3T are examples of an electronic device providing gesture tutorials for respective gestures performed by a finger-wearable device in accordance with some implementations.

FIG. 4 is an example of a flow diagram of a method of displaying a gesture tutorial for a finger-wearable device in accordance with some implementations.

FIG. 5 is another example of a flow diagram of a method of displaying a gesture tutorial for a finger-wearable device in accordance with some implementations.

### SUMMARY

An electronic device may be communicatively coupled with a secondary (e.g., auxiliary) device. Based on data from the secondary device, the electronic device may manipulate a computer-generated object. For example, a video game device uses data from a video game controller in order to manipulate a displayed video game character. However, the secondary device provides a limited amount of control, such as via a preset number of control buttons on the video game controller. Accordingly, the electronic device has a correspondingly limited ability to manipulate a computer-generated object based on data from the secondary device, resulting in a degraded user experience. For example, in order to provide inputs to a video game console, a user is limited to pressing preset buttons on a corresponding video game controller. Additionally, the efficiency of the object manipulation is based on the level of proficiency of a user operating the secondary device. Without adequate instruction, the user provides multiple control inputs to the secondary device in order to perform a single successful (e.g., intended) object manipulation operation. Accordingly, the electronic device utilizes excessive resources in order to obtain and process data associated with the unsuccessful control inputs.

By contrast, various implementations disclosed herein include methods, electronic devices, and systems that provide a gesture tutorial by displaying instructional content associated with a gesture to be performed by a finger-wearable device. Providing a gesture tutorial enables efficient user control, thereby improving the user experience and reducing resource utilization, as compared with other devices. To that end, an electronic device includes a communication interface provided to communicate with the finger-wearable device. The instructional content includes an object, such as a computer-generated table on which the finger-wearable device may perform a tap gesture. Based on finger manipulation data (e.g., inertial measurement unit (IMU) data, magnetic sensor data, interferometry data) from the finger-wearable device, the electronic device determines whether or not the finger-wearable device performs the gesture.

The electronic device determines an engagement score that characterizes a level of user engagement with respect to the object. The engagement score may characterize the extent to which a user wearing the finger-wearable device is focused on the object. For example, in some implementations, the engagement score is a function of an eye tracking input, extremity tracking input, or voice input associated with the user. As another example, in some implementations, the engagement score is a function of the finger manipulation data from the finger-wearable device, such as utilizing positional data in order to determine the finger-wearable device is less than a threshold distance from the object. In response to determining that the finger-wearable device performs the gesture, the electronic device displays a corresponding indicator in accordance with a determination that the engagement score satisfies an engagement criterion. For example, the electronic device displays the indicator when eye gaze data indicates that an eye gaze of a user is focused on the object while the finger-wearable device performs the gesture.

### DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

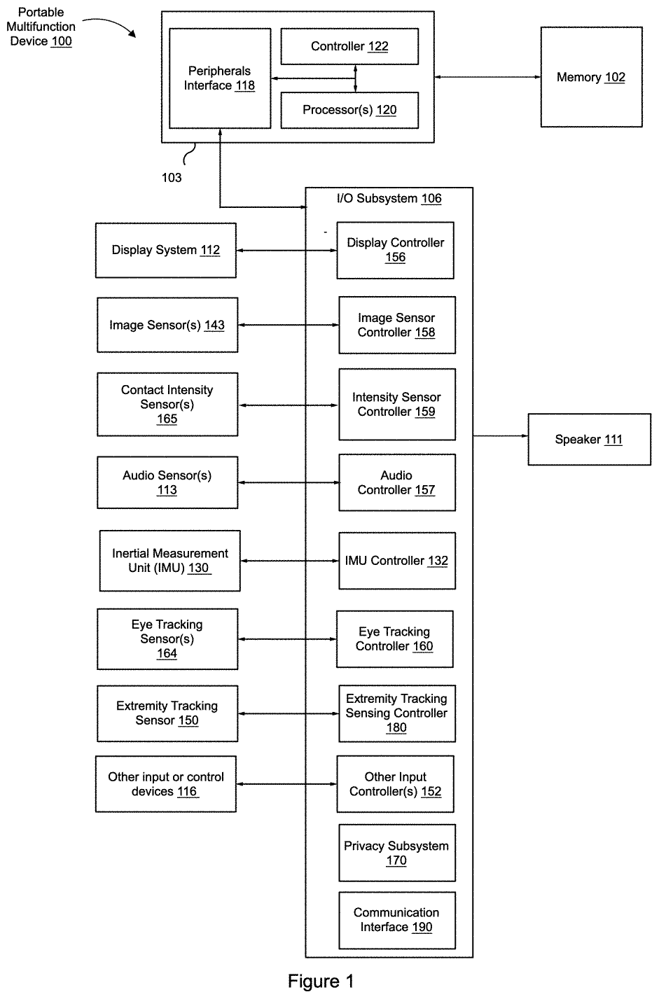

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, a privacy subsystem 170, and a communication interface 190. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, finger-wearable device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time of flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 may include a touch-sensitive surface, sensor, or set of sensors that accepts input from the user based on haptic and/or tactile contact. The display system 112 and the display controller 156 (along with any associated modules and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or a finger-wearable device.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The user optionally makes contact with the display system 112 using any suitable object or appendage, such as a stylus, a finger-wearable device, a finger, and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display.

The extremity tracking sensor 150 obtains extremity tracking data indicative of a position of an extremity of a user. For example, in some implementations, the extremity tracking sensor 150 corresponds to a hand tracking sensor that obtains hand tracking data indicative of a position of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes. As another example, the privacy subsystem 170 anonymizes certain types of user information likely to include sensitive and/or identifying information, independent of user designation (e.g., automatically).

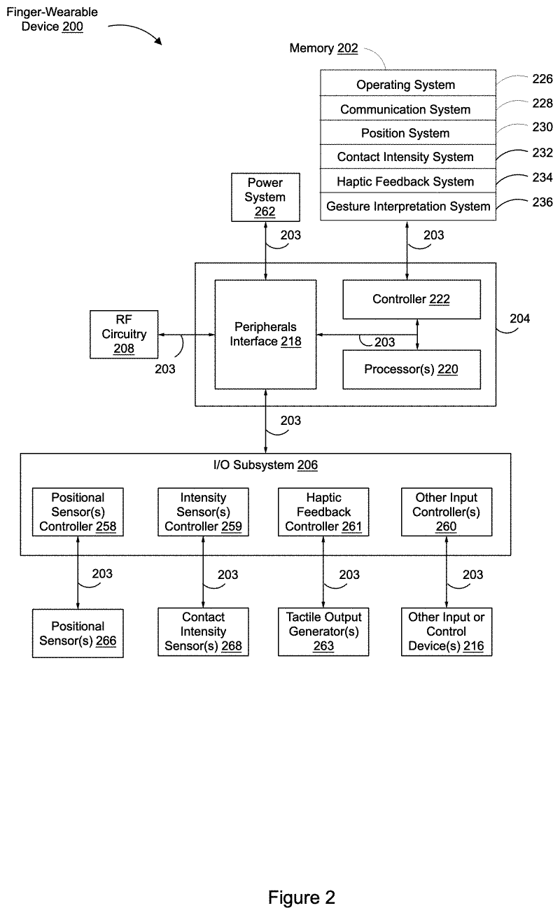

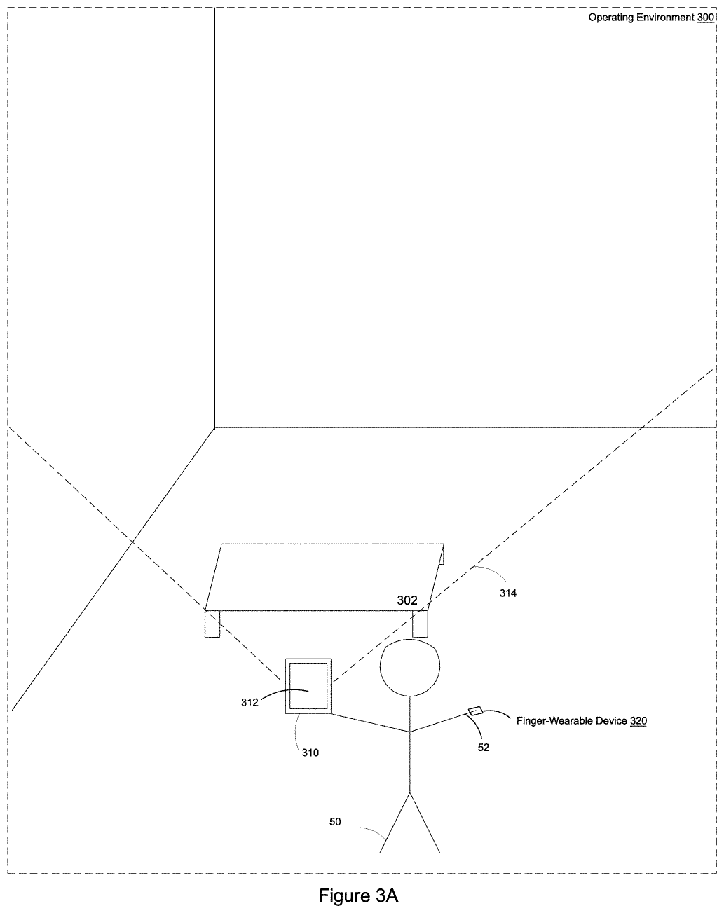

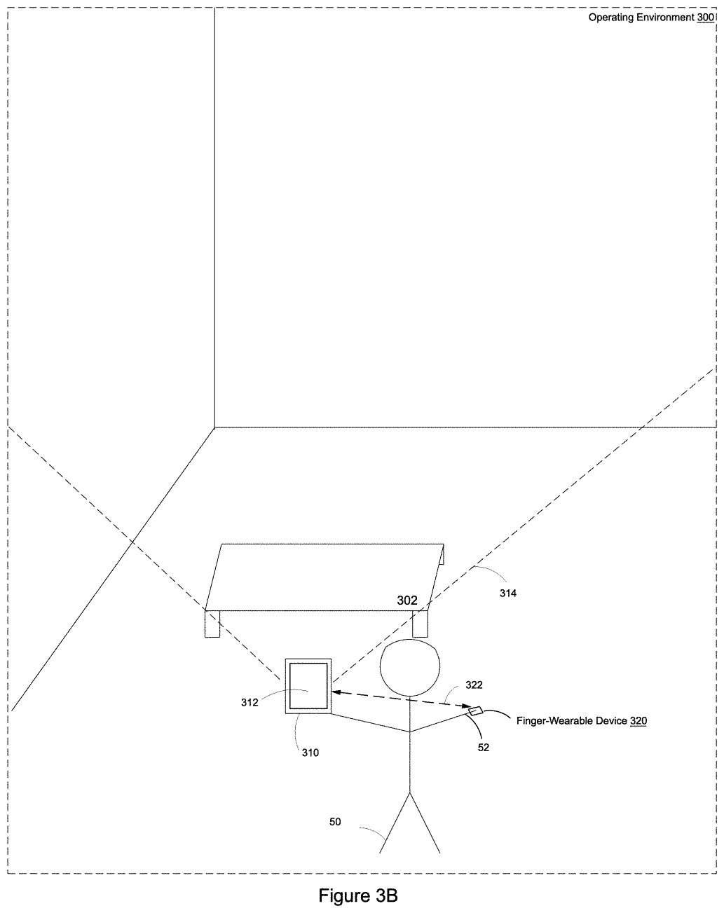

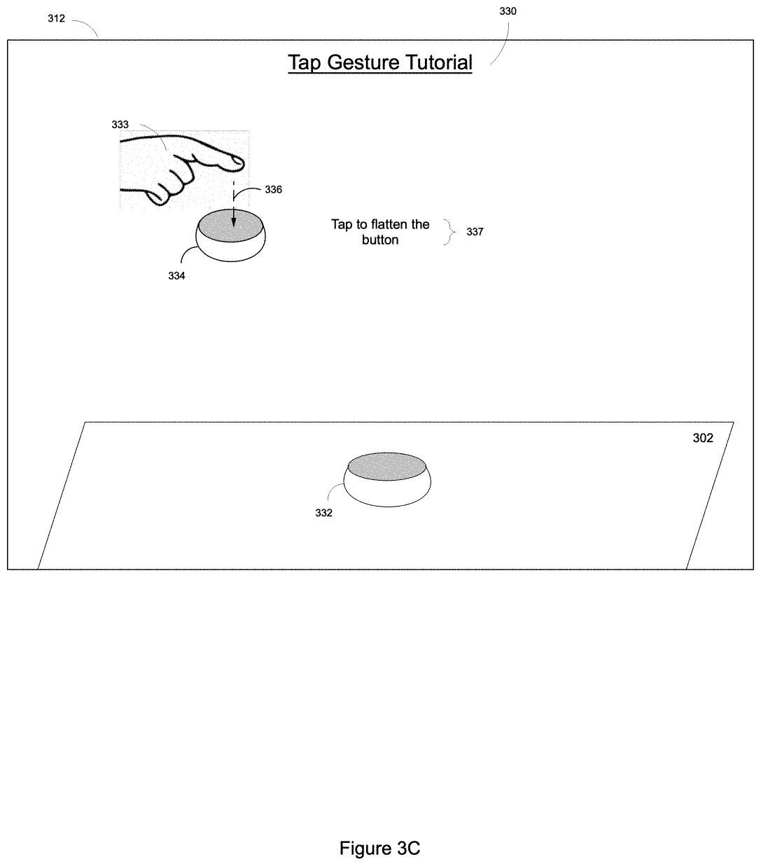

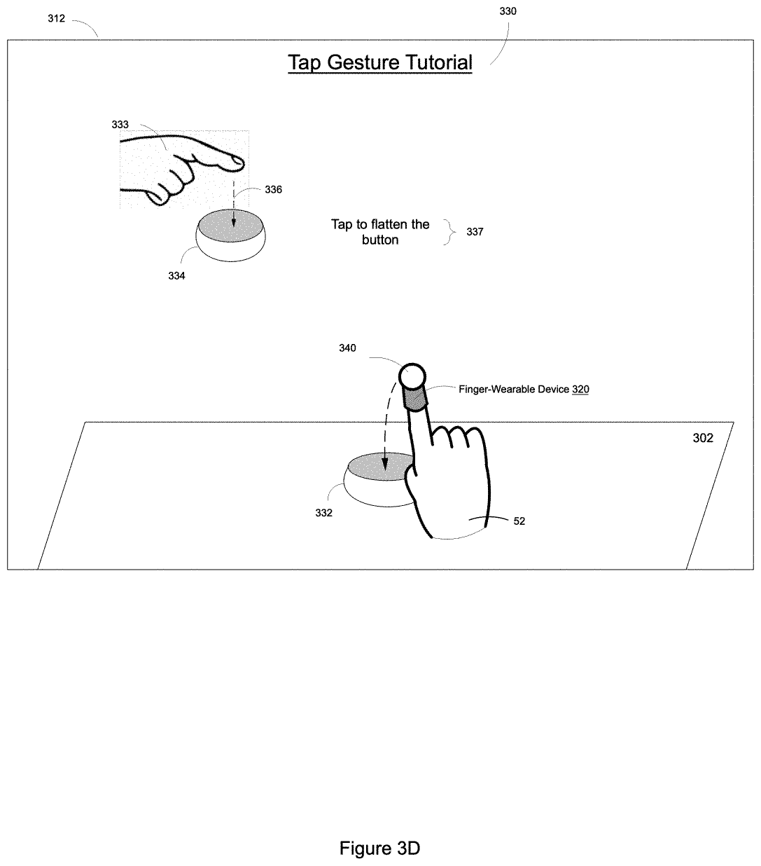

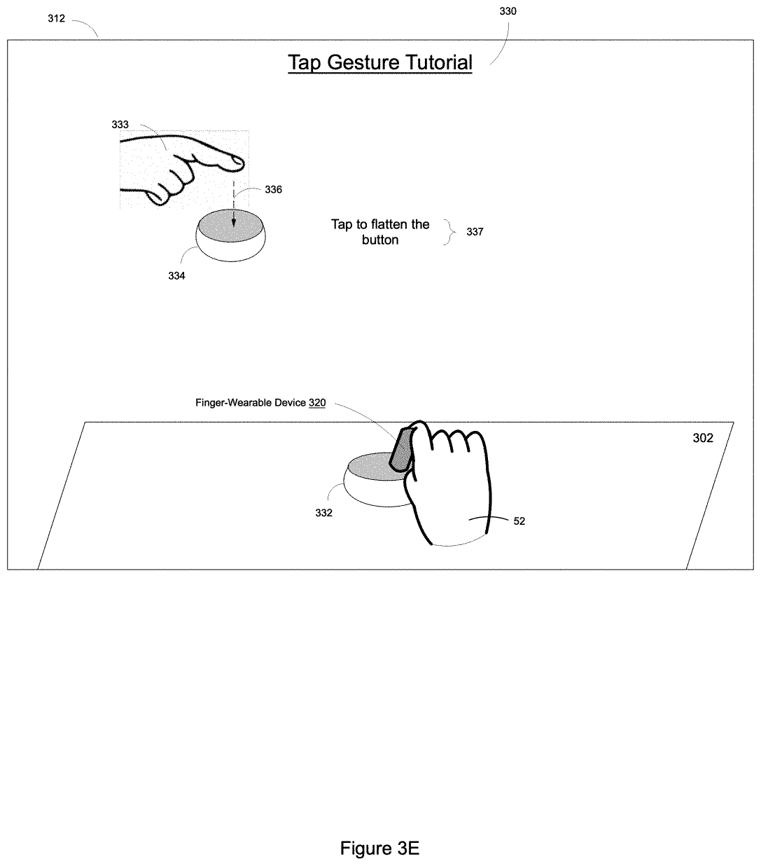

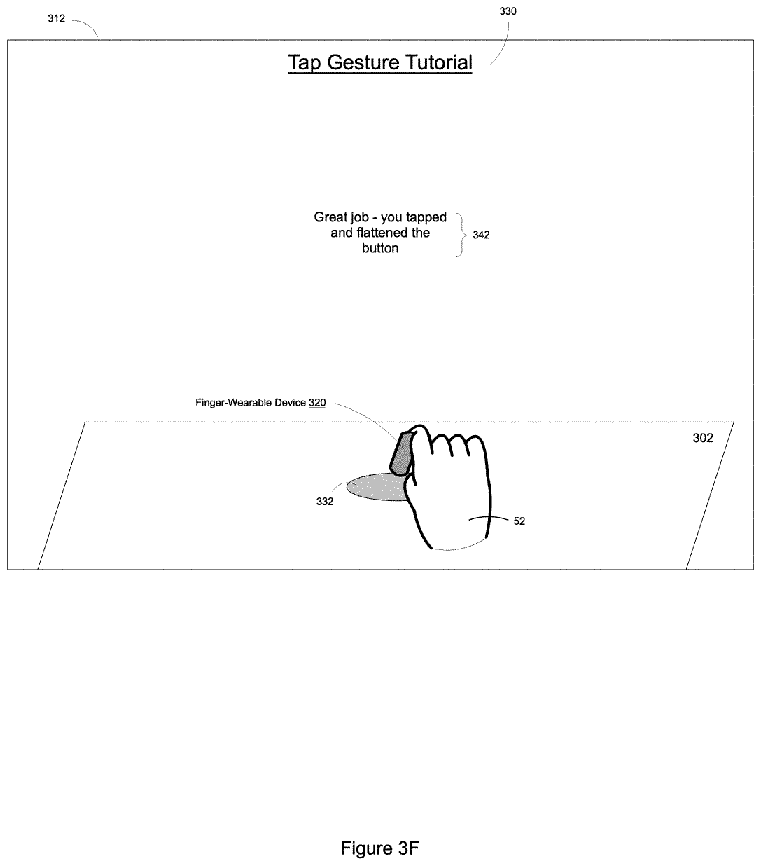

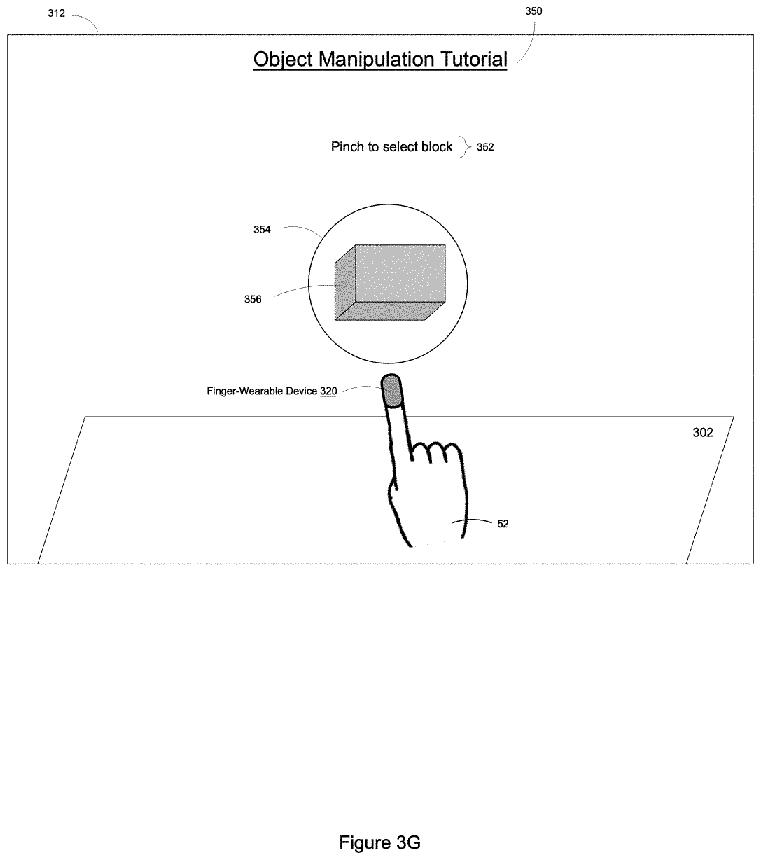

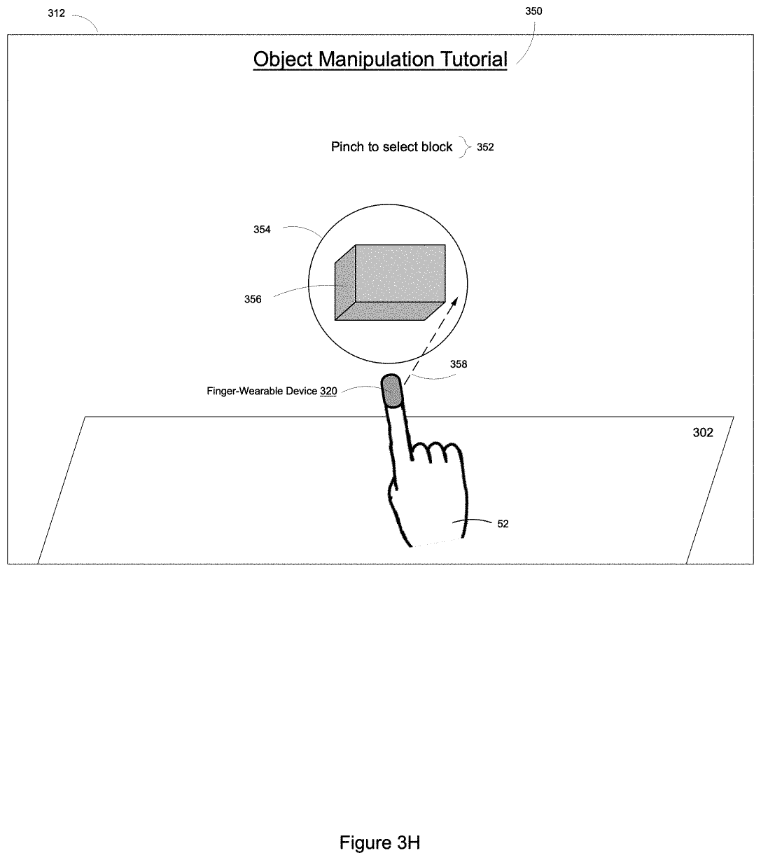

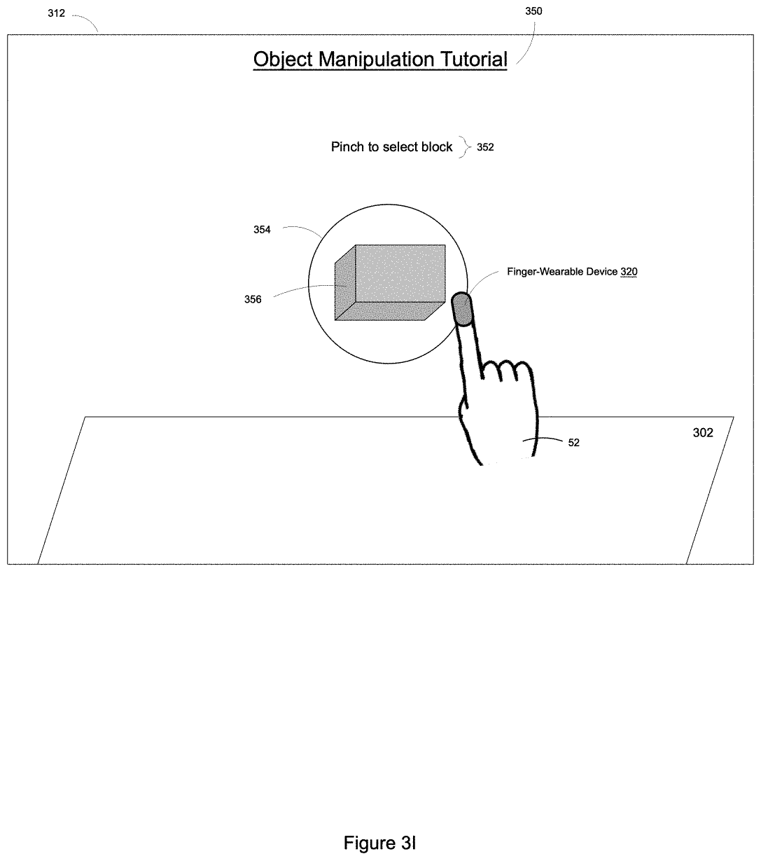

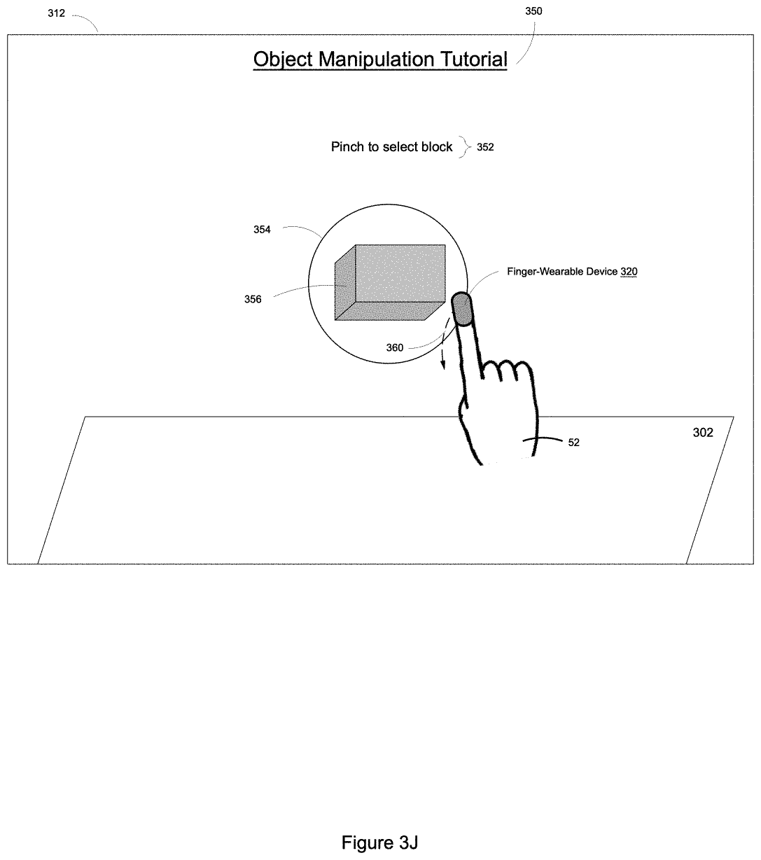

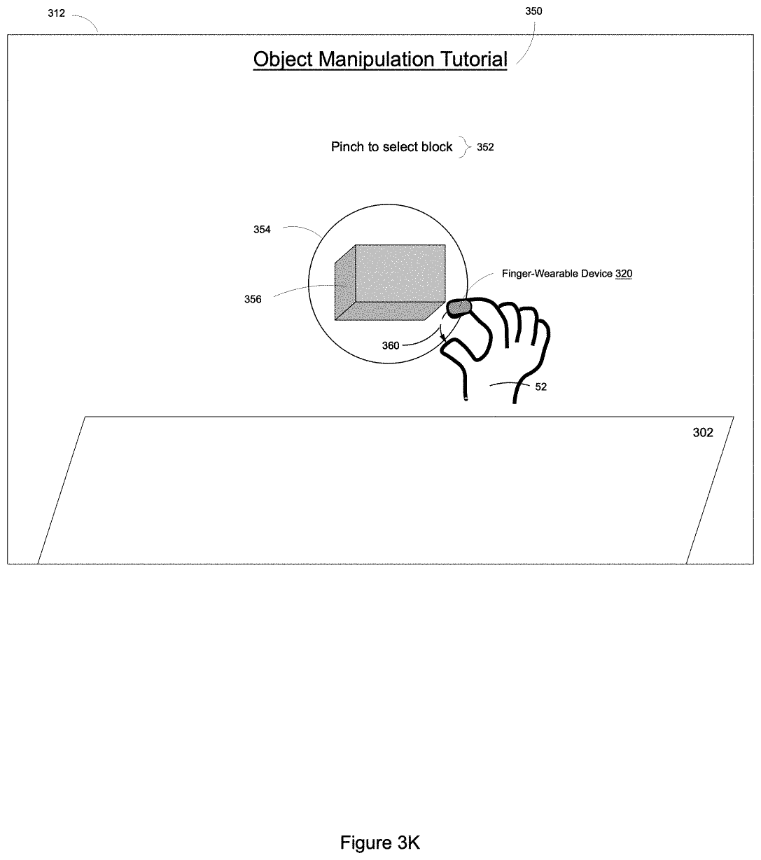

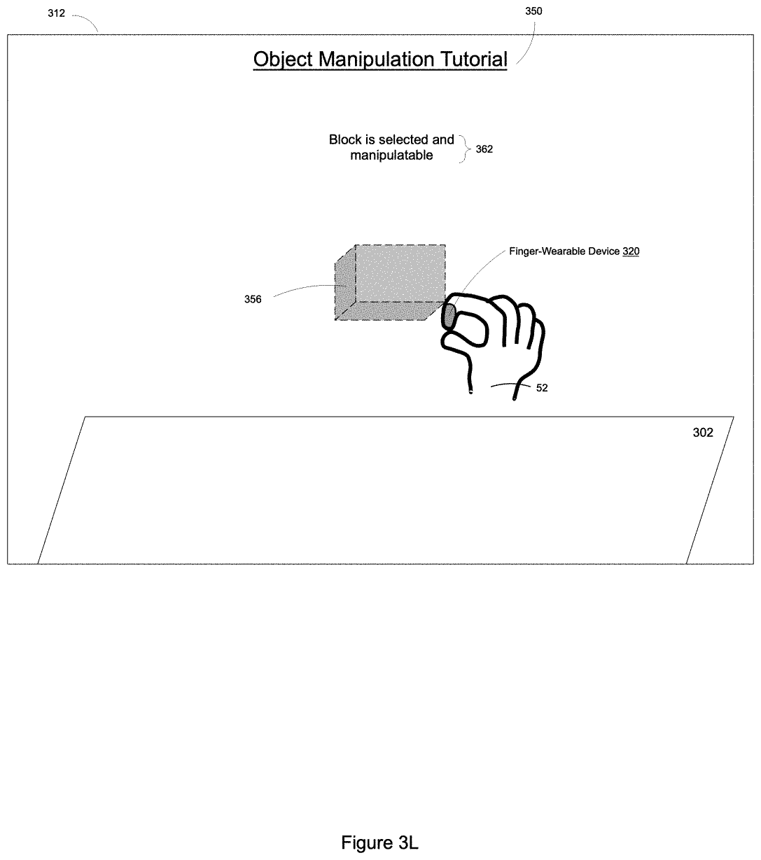

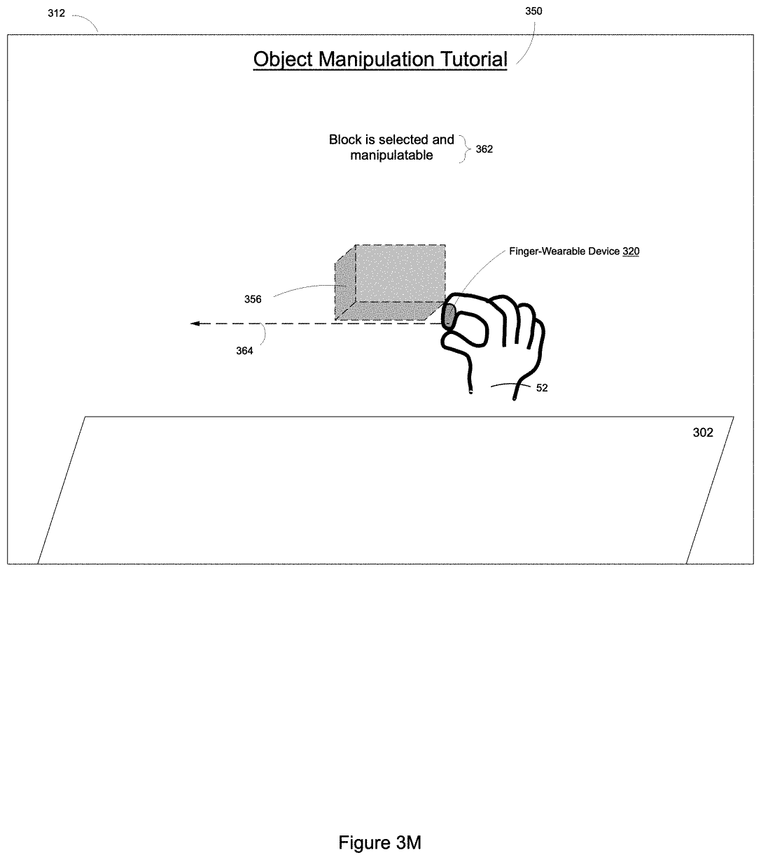

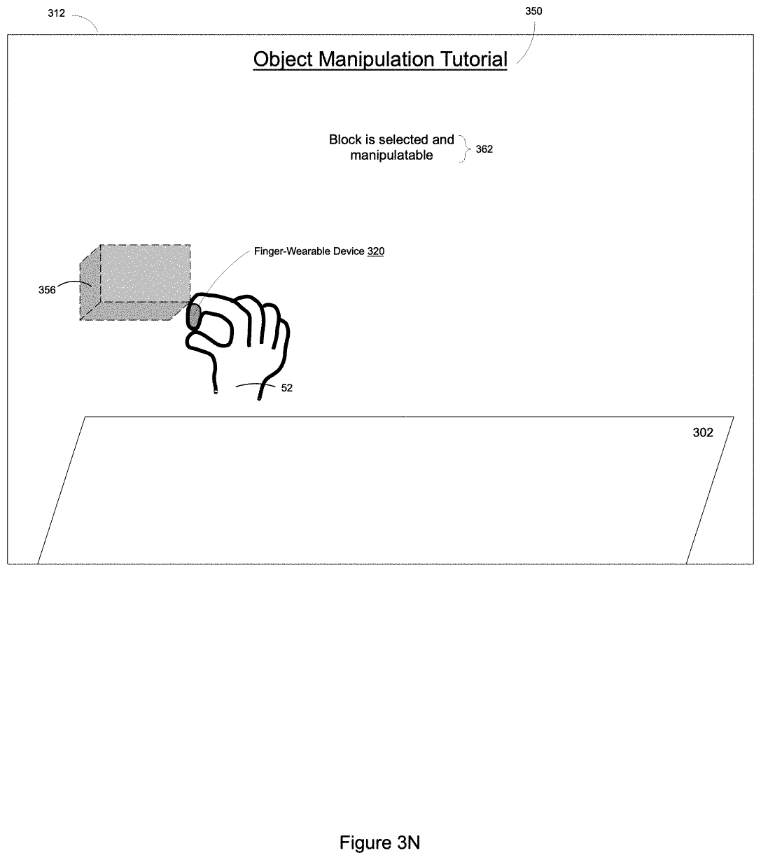

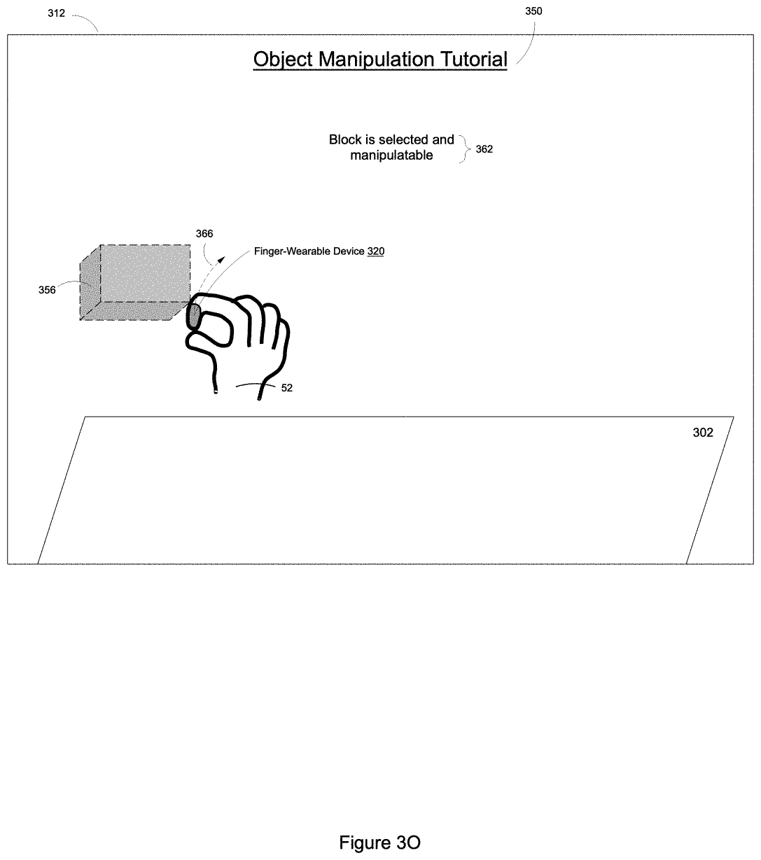

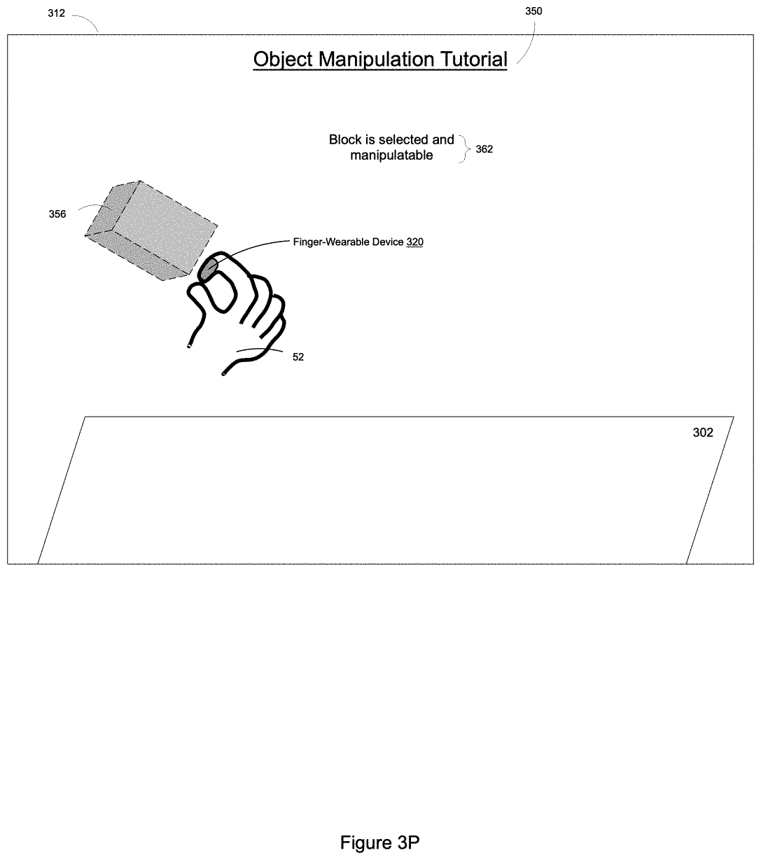

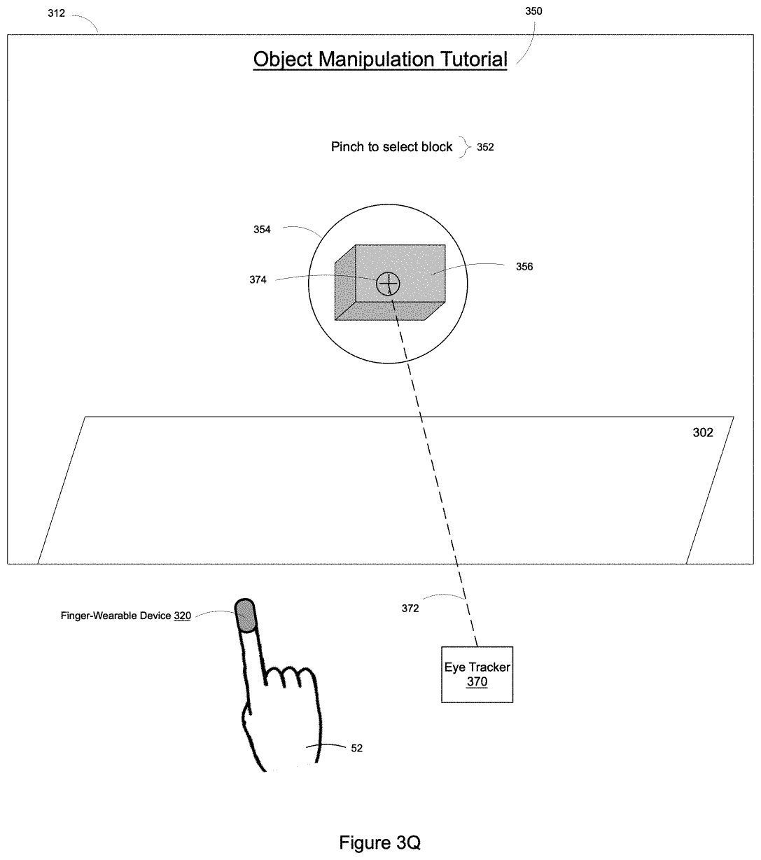

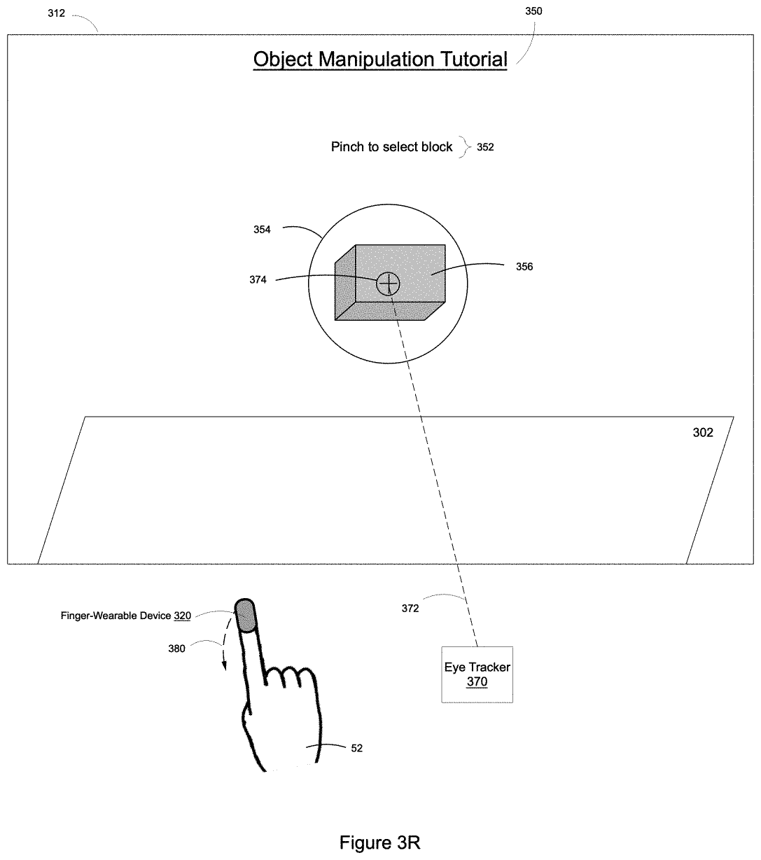

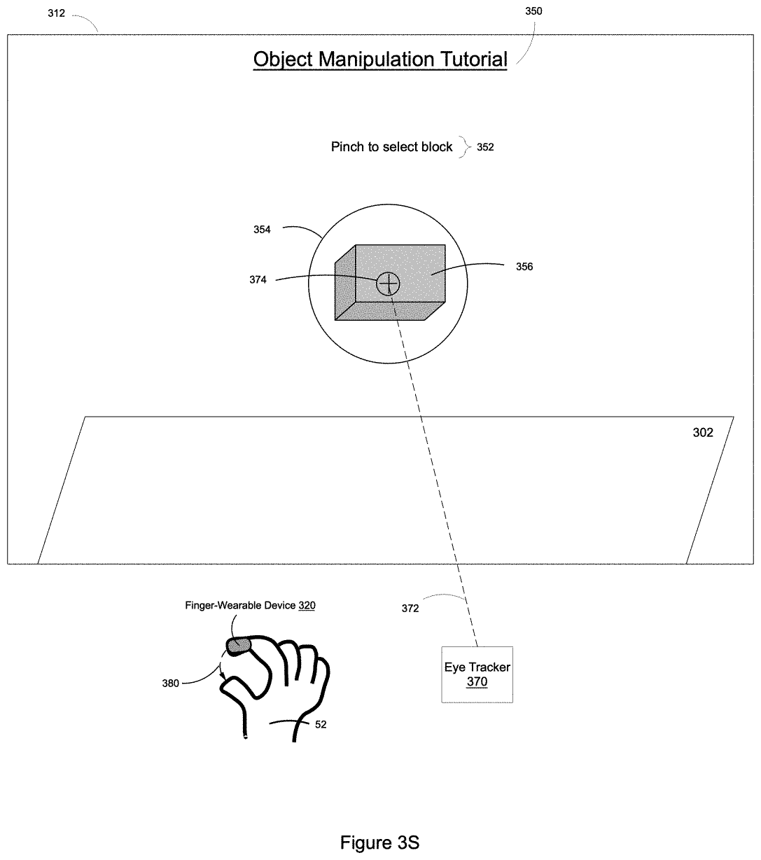

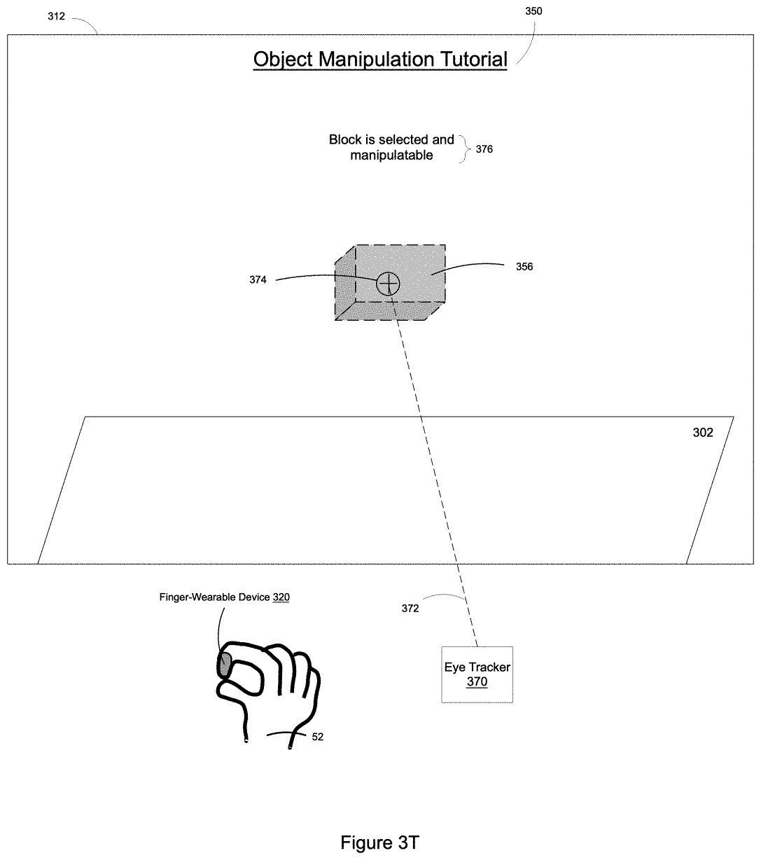

The electronic device 100 includes a communication interface 190 that is provided to communicate with a finger-wearable device, such as the finger-wearable device 200 illustrated in FIG. 2 or the finger-wearable device 320 in FIGS. 3A-3T. For example, the communication interface 190 corresponds to one of a BLUETOOTH interface, IEEE 802.11x interface, near field communication (NFC) interface, and/or the like. According to various implementations, the electronic device 100 obtains finger manipulation data from the finger-wearable device via the communication interface 190, as will be further described below.

FIG. 2 is a block diagram of an example of a finger-wearable device 200. The finger-wearable device 200 includes memory 202 (which optionally includes one or more computer readable storage mediums), memory controller 222, one or more processing units (CPUs) 220, peripherals interface 218, RF circuitry 208, and input/output (I/O) subsystem 206. These components optionally communicate over one or more communication buses or signal lines 203. One of ordinary skill in the art will appreciate that the finger-wearable device 200 illustrated in FIG. 2 is one example of a finger-wearable device, and that the finger-wearable device 200 optionally has more or fewer components than shown, optionally combines two or more components, or optionally has a different configuration or arrangement of the components. The various components shown in FIG. 2 are implemented in hardware, software, firmware, or a combination thereof, including one or more signal processing and/or application specific integrated circuits.

The finger-wearable device 200 includes a power system 262 for powering the various components. The power system 262 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices and/or portable accessories.

The memory 202 optionally includes high-speed random-access memory and optionally also includes non-volatile memory, such as one or more flash memory devices, or other non-volatile solid-state memory devices. Access to memory 202 by other components of the finger-wearable device 200, such as CPU(s) 220 and the peripherals interface 218, is, optionally, controlled by memory controller 222.

The peripherals interface 218 can be used to couple input and output peripherals of the finger-wearable device 200 to the CPU(s) 220 and the memory 202. The one or more processors 220 run or execute various software programs and/or sets of instructions stored in memory 202 to perform various functions for the finger-wearable device 200 and to process data.

In some implementations, the peripherals interface 218, the CPU(s) 220, and the memory controller 222 are, optionally, implemented on a single chip, such as chip 204. In some implementations, they are implemented on separate chips.

The RF (radio frequency) circuitry 208 receives and sends RF signals, also called electromagnetic signals. The RF circuitry 208 converts electrical signals to/from electromagnetic signals and communicates with the electronic device 100 or 310, communications networks, and/or other communications devices via the electromagnetic signals. The RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), BLUETOOTH, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

The I/O subsystem 206 couples input/output peripherals on the finger-wearable device 200, such as other input or control devices 216, with the peripherals interface 218. The I/O subsystem 206 optionally includes one or more positional sensor controllers 258, one or more intensity sensor controllers 259, a haptic feedback controller 261, and one or more other input controllers 260 for other input or control devices. The one or more other input controllers 260 receive/send electrical signals from/to other input or control devices 216. The other input or control devices 216 optionally include physical buttons (e.g., push buttons, rocker buttons, etc.), dials, slider switches, click wheels, and so forth. In some implementations, the other input controller(s) 260 are, optionally, coupled with any (or none) of the following: an infrared port and/or a USB port.

In some implementations, the finger-wearable device 200 includes one or more positional sensors 266 that output positional data associated with the finger-wearable device 200. The positional data is indicative of a position, orientation, or movement of the finger-wearable device 200, such as a rotational movement or translational movement of the finger-wearable device 200. For example, the positional sensor(s) 266 include an inertial measurement unit (IMU) that provides 3D rotational data, such as roll, pitch, and yaw information. To that end, the IMU may include a combination of an accelerometer, gyroscopes, and magnetometers. As another example, the positional sensor(s) 266 include a magnetic sensor that provides 3D positional data and/or 3D orientation data, such as the position of the finger-wearable device 200. For example, the magnetic sensor measures weak magnetic fields in order to determine a position of the finger-wearable device 200.

In some implementations, the finger-wearable device 200 includes one or more contact intensity sensors 268 for detecting intensity (e.g., pressure) of a contact of a finger wearing the finger-wearable device 200. The one or more contact intensity sensors 268 output contact intensity data associated with the finger-wearable device 200. As one example, the contact intensity data is indicative of the pressure associated with the finger-wearable device 200 while a finger of a user wearing the finger-wearable device 200 is tapping on (e.g., making contact with) a surface of a physical table. The one or more contact intensity sensors 268 may include an interferometer. The one or more contact intensity sensors 268 may include one or more piezoresistive strain gauges, capacitive force sensors, electric force sensors, piezoelectric force sensors, optical force sensors, capacitive touch-sensitive surfaces, or other intensity sensors.

The finger-wearable device 200 optionally includes one or more tactile output generators 263 for generating tactile outputs on the finger-wearable device 200. In some implementations, the term “tactile output” refers to physical displacement of an accessory (e.g., the finger-wearable device 200) of an electronic device (e.g., the electronic device 100) relative to a previous position of the accessory, physical displacement of a component of an accessory relative to another component of the accessory, or displacement of the component relative to a center of mass of the accessory that will be detected by a user with the user's sense of touch. For example, in situations where the accessory or the component of the accessory is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the accessory or the component of the accessory. For example, movement of a component (e.g., the housing of the finger-wearable device 200) is, optionally, interpreted by the user as a “click” of a physical actuator button. In some cases, a user will feel a tactile sensation such as a “click” even when there is no movement of a physical actuator button associated with the finger-wearable device that is physically pressed (e.g., displaced) by the user's movements. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., a “click,”), unless otherwise stated, the generated tactile output corresponds to physical displacement of the electronic device or a component thereof that will generate the described sensory perception for a typical (or average) user.

FIG. 2 shows the tactile output generator(s) 263 coupled with a haptic feedback controller 261. The tactile output generator(s) 263 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the electronic device). The tactile output generator(s) 263 receive tactile feedback generation instructions from a haptic feedback system 234 and generates tactile outputs on the finger-wearable device 200 that are capable of being sensed by a user of the finger-wearable device 200.

In some implementations, the software components stored in the memory 202 include an operating system 226, a communication system (or set of instructions) 228, a position system (or set of instructions) 230, a contact intensity system (or set of instructions) 232, a haptic feedback system (or set of instructions) 234, and a gesture interpretation system (or set of instructions) 236. Furthermore, in some implementations, the memory 202 stores device/global internal state associated with the finger-wearable device. The device/global internal state includes one or more of: sensor state, including information obtained from the finger wearable device's various sensors and other input or control devices 216; positional state, including information regarding the finger-wearable device's position (e.g., position, orientation, tilt, roll and/or distance) relative to an electronic device (e.g., the electronic device 100); and location information concerning the finger-wearable device's absolute position.

The operating system 226 includes various software components and/or drivers for controlling and managing general system tasks (e.g., memory management, power management, etc.) and facilitates communication between various hardware and software components.

The communication system 228 facilitates communication with other devices (e.g., the electronic device 100 or the electronic device 310), and also includes various software components (e.g., for handling data received by the RF circuitry 208) that are adapted for coupling directly to other devices or indirectly over a network (e.g., the Internet, wireless LAN, etc.).

The position system 230, in conjunction with positional data from the one or more positional sensor(s) 266, optionally detects positional information concerning the finger-wearable device 200. The position system 230 optionally includes software components for performing various operations related to detecting the position of the finger-wearable device 200 and detecting changes to the position of the finger-wearable device 200 in a particular frame of reference. In some implementations, the position system 230 detects the positional state of the finger-wearable device 200 relative to the electronic device and detects changes to the positional state of the finger-wearable device 200 relative to the electronic device. As noted above, in some implementations, the electronic device 100 or 310 determines the positional state of the finger-wearable device 200 relative to the electronic device and changes to the positional state of the finger-wearable device 200 using information from the position system 230.

The contact intensity system 232, in conjunction with contact intensity data from the one or more contact intensity sensor(s) 268, optionally detects contact intensity information associated with the finger-wearable device 200. The contact intensity system 232 includes software components for performing various operations related to detection of contact, such as detecting the intensity and/or duration of a contact between the finger-wearable device 200 and a desk surface. Determining movement of the point of contact, which is represented by a series of contact intensity data, optionally includes determining speed (magnitude), velocity (magnitude and direction), and/or an acceleration (a change in magnitude and/or direction) of the point of contact.

The haptic feedback system 234 includes various software components for generating instructions used by the tactile output generator(s) 263 to produce tactile outputs at one or more locations on finger-wearable device 200 in response to user interactions with the finger-wearable device 200.

The finger-wearable device 200 optionally includes a gesture interpretation system 236. The gesture interpretation system 236 coordinates with the position system 230 and/or the contact intensity system 232 in order to determine a gesture performed by the finger-wearable device. For example, the gesture includes one or more of: a pinch gesture, a pull gesture, a pinch and pull gesture, a rotational gesture, a tap gesture, and/or the like. In some implementations, the finger-wearable device 200 does not include a gesture interpretation system, and an electronic device determines a gesture performed by the finger-wearable device 200 based on finger manipulation data from the finger-wearable device 200. In some implementations, a portion of the gesture determination is performed at the finger-wearable device 200, and a portion of the gesture determination is performed at an electronic device. In some implementations, the gesture interpretation system 236 determines a time duration associated with a gesture. In some implementations, the gesture interpretation system 236 determines a contact intensity associated with a gesture, such as an amount of pressure associated with a user's finger tapping on a physical surface while the finger is wearing the finger-wearable device 200.

Each of the above identified modules and applications correspond to a set of executable instructions for performing one or more functions described above and the methods described in this application (e.g., the computer-implemented methods and other information processing methods described herein). These systems (i.e., sets of instructions) need not be implemented as separate software programs, procedures or modules, and thus various subsets of these modules are, optionally, combined or otherwise re-arranged in various embodiments. In some implementations, the memory 202 optionally stores a subset of the systems and data structures identified above. Furthermore, the memory 202 optionally stores additional systems and data structures not described above.

FIGS. 3A-3T are examples of an electronic device 310 providing gesture tutorials for respective gestures performed by a finger-wearable device 320 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein.

As illustrated in FIG. 3A, an electronic device 310 is associated with (e.g., operates according to) an operating environment 300. In some implementations, the electronic device 310 generates one of the XR settings described above. The operating environment 300 includes a physical table 302. The electronic device 310 includes a display 312 that is associated with a viewable region 314 of the operating environment 300. As illustrated in FIG. 3A, the viewable region 314 includes a portion of the physical table 302. In some implementations, the electronic device 310 corresponds to a mobile device, such as a smartphone, laptop, tablet, etc. In some implementations, the electronic device 310 is similar to and adapted from the electronic device 100 in FIG. 1. In some implementations, as illustrated in FIG. 3A, a user 50 is holding the electronic device 310.

In some implementations, the electronic device 310 corresponds to a head-mountable device (HMD) that includes an integrated display (e.g., a built-in display) that displays a representation of the operating environment 300. In some implementations, the electronic device 310 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the electronic device 310). For example, in some implementations, the electronic device 310 slides/snaps into or otherwise attaches to the head-mountable enclosure. In some implementations, the display of the device attached to the head-mountable enclosure presents (e.g., displays) the representation of the operating environment 300. For example, in some implementations, the electronic device 310 corresponds to a mobile phone that can be attached to the head-mountable enclosure. In various implementations, examples of the electronic device 310 include smartphones, tablets, media players, laptops, etc.

In some implementations, the electronic device 310 includes an image sensor, such as a scene camera. For example, the image sensor obtains image data that characterizes the operating environment 300, and the electronic device 310 composites the image data with computer-generated content in order to generate display data for display on the display 312. The display data may be associated with an XR environment. For example, the image sensor obtains image data that represents the portion of the physical table 302, and the generated display data displayed on the display 312 also represents the portion of the physical table 302 (See FIG. 3C).

In some implementations, the electronic device 310 includes a see-through display. The see-through display permits ambient light from the physical environment through the see-through display, and the representation of the physical environment is a function of the ambient light. For example, the see-through display is a translucent display, such as glasses with optical see-through. In some implementations, the see-through display is an additive display that enables optical see-through of the physical surface, such as an optical HMD (OHMD). For example, unlike purely compositing using a video stream, the additive display is capable of reflecting projected images off of the display while enabling the user to see through the display. In some implementations, the see-through display includes a photochromic lens. The HMD adds computer-generated objects to the ambient light entering the see-through display in order to enable display of the operating environment 300. For example, a see-through display 312 permits ambient light from the operating environment 300 that includes the portion of the physical table 302, and thus the see-through display 312 also represents the portion of the physical table 302 (See FIG. 3C).

As further illustrated in FIG. 3A, a finger-wearable device 320 is on a finger of a hand 52 of the user 50. In some implementations, the finger-wearable device 320 is similar to and adapted from the finger-wearable device 200 illustrated in FIG. 2. The electronic device 310 includes a communication interface (e.g., the communication interface 190 in FIG. 1) that is provided to communicate with the finger-wearable device 320. The electronic device 310 obtains finger manipulation data from the finger-wearable device 320. For example, the electronic device 310 obtains a combination of positional data (e.g., output by positional sensor(s) of the finger-wearable device 320) and contact intensity data (e.g., output by contact intensity sensor(s) of the finger-wearable device 320).

As illustrated in FIG. 3B, the electronic device 310 establishes a communication link with the finger-wearable device 320, as is indicated by a communication link line 322 (illustrated for purely explanatory purposes). Establishing the link between the electronic device 310 and the finger-wearable device 320 is sometimes referred to as pairing. One of ordinary skill in the art will appreciate that the electronic device 310 may communicate with the finger-wearable device 320 according to a variety of communication protocols, such as BLUETOOTH, IEEE 802.11x, NFC, etc.

In some implementations, in response to establishing a communication link with the finger-wearable device 320, the electronic device 310 (e.g., automatically) displays, on the display 312, first instructional content. In some implementations, after pairing and in response to detecting a user input, the electronic device 310 displays the first instructional content. For example, the electronic device 310 displays an affordance, and an eye gaze input (e.g., via the eye tracking sensor(s) 164 in FIG. 1) or an extremity tracking input (e.g., via the extremity tracking sensor 150) selects the affordance. In response to detecting selection of the affordance, the electronic device 310 displays the first instructional content.

FIGS. 3C-3F illustrate a tap gesture tutorial for the finger-wearable device 320. Accordingly, as illustrated in FIG. 3C, the first instructional content is associated with the tap gesture. The first instructional content includes a tap gesture tutorial indicator 330. The first instructional content also includes a first object with which the user 50 engages, as will be further described below. The first object corresponds to a first button 332. In some implementations, the electronic device 310 overlays the first button 332 onto a physical object, such as the surface of the physical table 302, as illustrated in FIG. 3C. To that end, in some implementations, the electronic device 310 obtains semantic values corresponding to respective physical objects represented within image data (e.g., obtained via an image sensor) in order to identify a suitable physical object, such as a surface or a wall. By displaying the first button 332 overlaid onto a physical object, the electronic device 310 may utilize content intensity data from the finger-wearable device 320 in order to determine a pressure associated with a finger of the hand 52 tapping on the physical object, while the finger is wearing the finger-wearable device 320.

In addition to including the first button 332, the first instructional content includes a hand 333, a second button 334, and text instruction 337. The hand 333 is shown hovering over the second button 334 in order to instruct the user 50 to tap the finger-wearable device 320 onto the first button 332. In some implementations, the first instructional content also includes a tap movement line 336 between the hand 333 and the second button 334 in order to provide additional instruction for the user 50 to tap the finger-wearable device 320 onto the first button 332. As another example, in addition to or instead of the tap movement line 336, the electronic display 310 displays an animation of the extended finger of the hand 333 tapping downwards towards the first button 334. The text instruction 337 instructs the user 50 to “Tap to flatten the button” in order to provide additional instruction to the user 50 regarding the tap gesture. In some implementations, the text instruction 337 includes a semantic value associated with a physical object. For example, when the electronic device 310 overlays the first button 332 onto the surface of the physical table 302, the text instruction 337 may include a corresponding semantic value, such as “Tap the table surface to flatten the button.”

As illustrated in FIGS. 3D and 3E, the finger-wearable device 320 performs a tap gesture, as is indicated by tap indictor 340 (illustrated for purely explanatory purposes). Accordingly, based on positional data (e.g., IMU data and 3D magnetic sensor data) from the finger-wearable device 320, the electronic device 310 determines that the finger-wearable device 320 performs the tap gesture. For example, the electronic device 310 determines that the positional data is indicative of a rotational downward movement by the finger-wearable device 320. In some implementations, the electronic device 310 uses IMU data in order to predict a touch between a finger and a physical surface, and uses interferometer data to detect the actual touch between the finger and the physical surface based on deflection.

In response to determining that the finger-wearable device 320 performs the tap gesture, the electronic device 310 determines whether or not an engagement score satisfies an engagement criterion with respect to the first button 332. The engagement score characterizes a level of user engagement with respect to the first button 332. In some implementations, the electronic device 310 determines, based on positional data (e.g., magnetic sensor data) from the finger-wearable device 320, that the engagement score satisfies the engagement criterion because the position of the finger-wearable device 320 during the tap gesture satisfies a proximity threshold with respect to the first button 332. For example, as illustrated in FIG. 3E, the positional data indicates that the tap gesture spatially intersects the top gray portion of the first button 332. In some implementations, the electronic device 310 determines that the engagement score satisfies the engagement criterion when the finger-wearable device 320 satisfies the proximity threshold and satisfies a pressure threshold (e.g., based on contact intensity data) based on a contact between a finger, wearing the finger-wearable device 320, and the physical table 302. In some implementations, the first button 332 is flat (e.g., a 2D button) and overlaid on a physical surface, and the electronic device 310 determines satisfaction of the engagement criterion based on a combination of pressure information (e.g., interferometer data) and positional information (e.g., magnetic sensor data).

In response to determining that the engagement score satisfies the engagement criterion, the electronic device 310 displays, on the display 312, an indication indicating that the first gesture is directed to the first object. For example, as illustrated in FIG. 3F, the electronic device 310 displays an indicator 342 indicating “Great job—you tapped and flattened the button.” Moreover, in some implementations, the electronic device 310 changes the appearance of the first button 332 in order to appear flattened as a further indication. On the other hand, in response to determining that the engagement score does not satisfy the engagement criterion during the gesture, the electronic device 310 foregoes displaying an indication. Accordingly, false positives resulting from erroneous (e.g., unintended) gesture inputs are avoided, improving the gesture tutorial experience and reducing resource utilization by the electronic device 310 not displaying an indication.

FIGS. 3G-3T illustrate an object manipulation gesture tutorial for the finger-wearable device 320. In some implementations, the electronic device 310 presents the object manipulation gesture tutorial in response to establishing a communication with the finger-wearable device 320. In some implementations, a user input (e.g., eye tracking input, extremity tracking input, finger-wearable device input) specifies a desired gesture tutorial. For example, the electronic device 310 detects a gesture change request that requests a change from the tap gesture tutorial to the object manipulation gesture tutorial.

As illustrated in FIG. 3G, the electronic device 310 displays, on the display 312, second instructional content associated with an object manipulation gesture. The second instructional content includes an object manipulation tutorial indicator 350 and a text instruction 352 instructing the user 50 to “Pinch to select block.” The second instructional content also includes a second object, corresponding to a floating block 356, with which the user 50 engages. The second instructional content also includes a ring 354 surrounding the floating block 356. Similar to as described above, the electronic device 310 determines an engagement score that characterizes a level of user engagement with respect to the floating block 356. In some implementations, the engagement score satisfies an engagement criterion when the engagement score indicates that the user engagement is associated with the ring 354, such as being within the ring 354. For example, as illustrated in FIGS. 3H and 31, the finger-wearable device 320 moves to within the ring 354.

As illustrated in FIGS. 3J-3L, the electronic device 310 determines that the finger-wearable device 320 performs a pinch gesture based on positional data from the finger-wearable device 320. The pinch gesture 360 is indicated by pinch line 360, which is illustrated for purely explanatory purposes. In response to determining that the finger-wearable device 320 performs the pinch gesture, the electronic device 310 determines whether or not the engagement score satisfies the engagement criterion. For example, based on the positional data, the electronic device 310 determines that the finger-wearable device 320 is within the ring 354 while performing the pinch gesture and thus is sufficiently proximate to the floating block 356. Accordingly, the electronic device 310 determines that the engagement score satisfies the engagement criterion.

As illustrated in FIG. 3L, in response to determining that the engagement score satisfies the engagement criterion, the electronic device 310 displays an indication 362 indicating that the “Block is selected and manipulatable.” In other words, the indication 362 indicates that the finger-wearable device 320 successfully selects the floating block 356 via the pinch gesture. As an additional indication, as illustrated in FIG. 3L, the electronic device 310 may cease to display the ring 354 and change the appearance of the floating block 356 from solid-lined to dotted-lined.

Because the floating block 356 is selected, the electronic device 310 utilizes finger manipulation data from the finger-wearable device 320 in order to manipulate (e.g., change an appearance of) the floating block 356. For example, as illustrated in FIG. 3M, positional data indicates a leftwards movement of the finger-wearable device 320, as illustrated by movement line 364 (illustrated for purely explanatory purposes). Based on the positional data, the electronic device 310 correspondingly moves the floating block 356 leftwards, as illustrated in FIG. 3N. As another example, as illustrated in FIG. 3O, positional data indicates a clockwise rotation of the finger-wearable device 320, as illustrated by movement line 366 (illustrated for purely explanatory purposes). Based on the positional data, the electronic device 310 correspondingly rotates the floating block 356 clockwise, as illustrated in FIG. 3P. One of ordinary skill in the art will appreciate that the electronic device 310 may perform other manipulation operations based on different movement types performed by the finger-wearable device 320, such as enlarging, shrinking, zooming in/out, changing color, etc.

In some implementations, the electronic device 310 determines an engagement score independent of finger manipulation data from the finger-wearable device 320. For example, in some implementations, as illustrated in FIGS. 3Q-3T, the electronic device 310 determines the engagement score based on eye tracking data from an eye tracker 370 (e.g., the eye tracking sensor(s) 164 in FIG. 1). The eye tracking data is indicative of an eye gaze 372 of one or more eyes of the user 50. Based on the eye gaze 372, the electronic device 310 determines that the user 50 is focused within the ring 354, on the floating block 356. The focus of the user 50 is indicated by reticle 374, which may be displayed on the display 312 in order to provide feedback to the user 50. In response to determining that the finger-wearable device 320 performs the pinch gesture (indicated by pinch line 380) in FIGS. 3R-3T, the electronic device 310 determines that the engagement score satisfies the engagement criterion because the focus of the user 50 is within the ring 354, independent of the position of the finger-wearable device 320 relative to the ring 354. In response to determining that the engagement score satisfies the engagement criterion, the electronic device 310 displays, on the display 312, an indication 376 that the “Block is selected and manipulatable” and changes the appearance of the floating block 356. Notably, as illustrated in FIGS. 3Q-3T, the gesture tutorial may operate even when the finger-wearable device 320 is not viewable on the display 312. For example, the user 50, while sitting on a couch, rests the hand 52 and the finger-wearable device 320 on an edge of the couch, enabling a more comfortable experience for the user 50 and thereby potentially reducing erroneous inputs from the finger-wearable device 320.

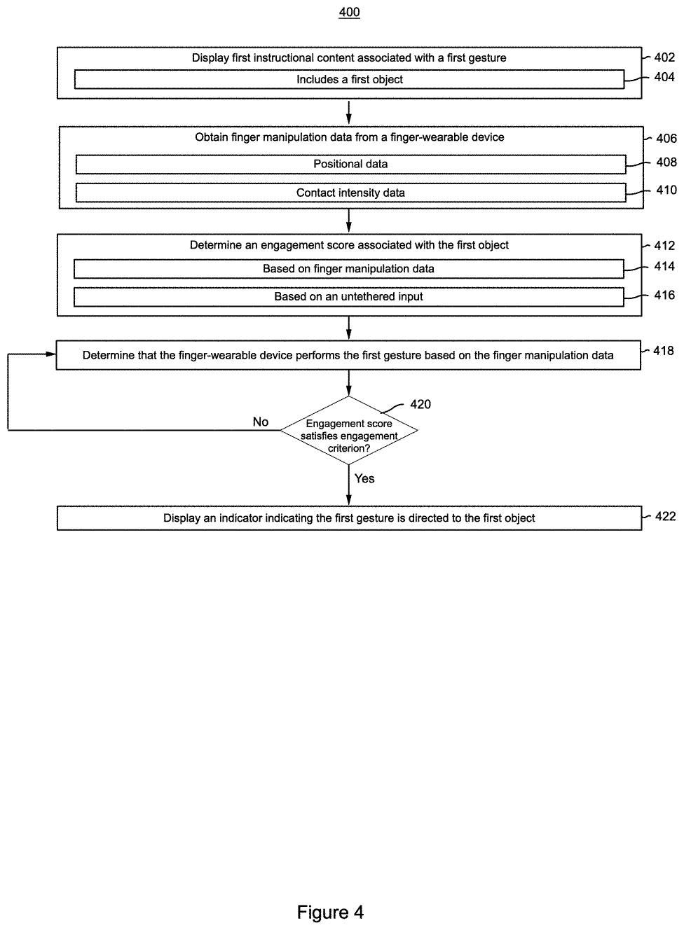

FIG. 4 is an example of a flow diagram of a method 400 of displaying a gesture tutorial for a finger-wearable device in accordance with some implementations. In various implementations, the method 400 or portions thereof are performed by an electronic device (e.g., the electronic device 100 in FIG. 1 or the electronic device 310 in FIGS. 3A-3T). In various implementations, the method 400 or portions thereof are performed by a head-mountable device (HMD). In some implementations, the method 400 is performed by processing logic, including hardware, firmware, software, or a combination thereof. In some implementations, the method 400 is performed by a processor executing code stored in a non-transitory computer-readable medium (e.g., a memory). In various implementations, some operations in method 400 are, optionally, combined and/or the order of some operations is, optionally, changed.

As represented by block 402, the method 400 includes displaying, on a display, first instructional content that is associated with a first gesture, such as a pinch gesture, pull gesture, swipe gesture, rotational gesture, etc. In some implementations, the first instructional content includes a contact intensity level indicator indicating a level of contact (e.g., pressure, force, etc.) associated with a tap gesture. The contact intensity indicator may be a function of contact intensity data (e.g., interferometer data) from the finger-wearable device. In some implementations, the first instructional content includes a representation of the finger-wearable device, and the representation of the finger-wearable device is based on the finger manipulation data. Displaying the representation of the finger-wearable device provides feedback to the user, thereby enabling more accurate inputs from the user.

As represented by block 404, the first instructional content includes a first object. For example, with reference to FIG. 3C, the first object corresponds to the first button 332. As another example, the first instructional content includes text corresponding to “Tap table three times,” and the first object is a virtual button on a physical table on which a finger (wearing the finger-wearable device) taps.

As represented by block 406, the method 400 includes obtaining finger manipulation data from the finger-wearable device via a communication interface. In some implementations, the finger manipulation data includes a combination of positional data (e.g., indicating six degrees of freedom) and contact intensity data associated with the finger-wearable device. The finger manipulation data may include sensor data associated with one or more sensors integrated within the finger-wearable device. For example, in some implementations, as represented by block 408, the sensor data includes positional data, such as from an IMU or magnetic sensor integrated in the finger-wearable device. The positional data may be indicative of a position, orientation, or movement (e.g., rotational movement or translational movement) of the finger-wearable device. As another example, in some implementations, as represented by block 410, the sensor data includes contact intensity data from a content intensity sensor (e.g., an interferometer) integrated in the finger-wearable device. The contact intensity data may be indicative of a tap force of pressure associated with a gesture that is performed by the finger-wearable device. For example, the finger-wearable device senses (e.g., via the contact intensity sensor) deflection of a pad of a finger when the finger contacts the physical surface. Accordingly, various implementations disclosed herein enable a user to feel a physical surface (and the texture of the physical surface) with which the user is interacting.

As represented by block 412, the method 400 includes determining an engagement score that characterizes a level of user engagement with respect to the first object. The engagement score characterizes the extent to which the user is focused on the first object. For example, in some implementations, as represented by block 414, the engagement score is based on the finger manipulation data from the finger-wearable device. As one example, with reference to FIG. 3D, the electronic device 310 determines that, as the finger-wearable device 320 begins a tap gesture, the position of the finger-wearable device 320 is relatively close to the top surface of the first button 332 based on positional data from the finger-wearable device 320. Accordingly, the electronic device 310 determines a correspondingly high engagement score. As another example, in some implementations, as represented by block 416, the engagement score is based on an untethered input from a first input device. The untethered input is independent of the finger manipulation data. For example, the untethered input is an eye tracking input, extremity tracking input, or voice input (e.g., “initiate engagement with the object”). As one example, with reference to FIG. 3R, the electronic device 310 determines that, as the finger-wearable device 320 begins a pinch gesture, eye gaze data from the eye tracker 370 indicates that the focus of the user 50, as indicated by the reticle 374 is on the floating block 356, within the ring 354. Accordingly, the electronic device 310 determines a correspondingly high engagement score. In some implementations, the extremity tracking utilizes a computer vision technique (e.g., semantic segmentation), optionally with the aid of a neural network, in order to determine a position of an extremity of a user relative to the first object.

As represented by block 418, the method 400 includes determining that the finger-wearable device performs the first gesture based on a function of the finger manipulation data. For example, with reference to FIGS. 3D-3F, the electronic device 310 determines that the finger-wearable device 320 performs a tap gesture associated with the tap gesture tutorial, based on the finger manipulation data. As another example, with reference to FIGS. 3J-3L, the electronic device 310 determines that the finger-wearable device 320 performs a pinch gesture associated with the object manipulation tutorial gesture tutorial, based on the finger manipulation data. In some implementations, determining that the finger-wearable device performs the first gesture includes detecting skin deflection based on interferometer data.

As represented by block 420, in response to determining that the finger-wearable device performs the first gesture, the method 400 includes determining whether or not the engagement score satisfies an engagement criterion. For example, the method 400 includes determining whether or not the engagement score satisfies the engagement criterion within a time threshold from determining that the finger-wearable device performs the first gesture. In some implementations, the method 400 includes identifying a respective location (e.g., position in 3D space) that corresponds to the finger-wearable device based on a function of the positional data, and determining that the engagement score satisfies the engagement criterion based on the respective location satisfying a proximity threshold with respect to the first object. In some implementations, in response to determining that the respective location satisfies the proximity threshold with respect to the first object, the method 400 includes setting a user handedness value (e.g., left-handed or right-handed) based on a function of the finger manipulation data. Accordingly, the method 400 may include determining a user hand preference without receiving an input from a user specifying the user hand preference. Moreover, in some implementations, setting the user handedness value is based on a comparison between the respective location (e.g., position in 3D space) that corresponds to the finger-wearable device and one or more locations that respectively correspond to one or more user extremities. To that end, in some implementations, an electronic device performing the method 400 includes an extremity tracking system that outputs extremity tracking data, wherein the extremity tracking data is indicative of the one or more locations that respectively correspond to the one or more user extremities.

In some implementations, the method 400 includes identifying a first location based on a function of the untethered input, and determining that the engagement score satisfies the engagement criterion based on the first location satisfying a proximity threshold with respect to the first object. As another example, with reference to FIGS. 3D-3F, during the tap gesture the electronic device 310 determines that that the engagement score satisfies the engagement criterion because the finger-wearable device 320 is less than a threshold distance away from the first button 332. As yet another example, with reference to FIGS. 3R-3T, during the pinch gesture the electronic device 310 determines that that the engagement score satisfies the engagement criterion because eye tracking data indicates that a gaze 372 of the user 50 is focused within the ring 354.

In response to determining that the engagement score satisfies the engagement criterion, the method 400 proceeds to a portion of the method 400 represented by block 422. As represented by block 422, the method 400 includes displaying, on the display, an indication indicating that the first gesture is directed to the first object. For example, displaying the indication includes changing an appearance of the first object, such as changing the floating block 356 to from having solid lines dotted lines in FIGS. 3K and 3L. As another example, displaying the indication includes changing the first instructional content, such as changing text from “Tap to flatten the button” 337 to “Great job—you tapped and flattened the button” 342, as illustrated in FIGS. 3E and 3F. In some implementations, the indication indicates the first gesture, such as “You successfully performed a tap gesture.” As another example, a displayed dial turns from red to green in response to a successful radial gesture. As yet another example, in response to a tap on the table, a displayed tap counter changes from “tap three times” to “tap two times.”

On the other hand, in response to determining that the engagement score does not satisfy the engagement criterion, the method 400 foregoes displaying an indication and reverts to the portion of the method 400 represented by block 418. For example, as a finger-wearable device performs the first gesture, if the user is not looking at the first object and the finger-wearable device is not proximate to the first object, the indication is not displayed.

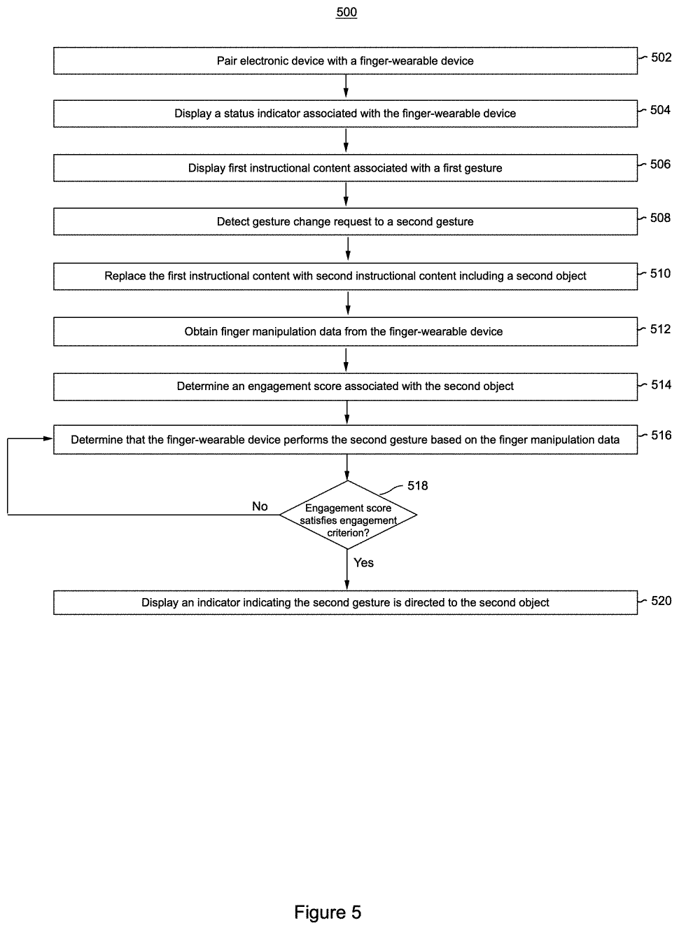

FIG. 5 is another example of a flow diagram of a method 500 of displaying a gesture tutorial for a finger-wearable device in accordance with some implementations. In various implementations, the method 500 or portions thereof are performed by an electronic device (e.g., the electronic device 100 in FIG. 1 or the electronic device 310 in FIGS. 3A-3T). In various implementations, the method 500 or portions thereof are performed by a head-mountable device (HMD). In some implementations, the method 500 is performed by processing logic, including hardware, firmware, software, or a combination thereof. In some implementations, the method 500 is performed by a processor executing code stored in a non-transitory computer-readable medium (e.g., a memory). In various implementations, some operations in method 500 are, optionally, combined and/or the order of some operations is, optionally, changed.

As represented by block 502, in some implementations, the method 500 includes an electronic device establishing a link with a finger-wearable device, sometimes referred to as pairing. To that end, in some implementations, the method 500 includes detecting that the finger-wearable device is proximate to the electronic device, and in response to detecting that the finger-wearable device is proximate to the electronic device, pairing the electronic device with the finger-wearable device. For example, with reference to FIG. 3B, the electronic device 310 pairs with the finger-wearable device 320, as indicated via communication link line 322. For example, the finger-wearable device being proximate to the electronic device corresponds to being physically proximate to (e.g., near to) the finger-wearable device. Pairing includes making a communication link functional. For example, pairing includes enabling a cooperative link between the finger-wearable device and the electronic device.

As represented by block 504, in some implementations, in response to pairing with the finger-wearable device, the method 500 includes displaying a status indicator indicating status information associated with the finger-wearable device. To that end, in some implementations, the method 500 includes obtaining, from the finger-wearable device via the communication interface, status information associated with the finger-wearable device, and in response to obtaining the status information, displaying, on the display, the status indicator. For example, the status information includes model/firmware info of the finger-wearable device, settings of the finger-wearable device (e.g., sensitivity setting). As another example, the status indicator indicates that the finger-wearable device is paired with the electronic device. As yet another example, the status indicator indicates a battery life associated with the finger-wearable device.

As represented by block 506, in some implementations, in response to pairing with the finger-wearable device, the method 500 includes displaying first instructional content that is associated with a first gesture. The first instructional content includes a first object. For example, in response to pairing with the finger-wearable device 320 as illustrated in FIG. 3B, the electronic device 310 displays (e.g., automatically, without user intervention) the first instructional content associated with the tap gesture tutorial as illustrated in FIG. 3C.

In some implementations, the method 500 includes changing from the first instructional content associated with the first gesture to second instructional content associated with a second gesture that is different from the first gesture. To that end, as represented by block 508, the method 500 includes detecting a gesture change request associated with a second gesture. In some implementations, detecting the gesture change request is based on a function of the finger manipulation data. In some implementations, detecting the gesture change request is based on a function of an untethered input (e.g., eye gaze input, extremity tracking input, voice input, etc.). Further to that end, as represented by block 510, the method 500 includes, in response to detecting the gesture change request, replacing the first instructional content with second instructional content. The second instructional content is associated with a second gesture that is different from the first gesture. Moreover, the second instructional content includes a second object.

As represented by block 512, the method 500 includes obtaining finger manipulation data from the finger-wearable device via a communication interface. For example, in some implementations, the portion of the method 500 represented by block 512 is similar to the portion of the method 400 represented by block 406.

As represented by block 514, the method 500 includes determining an engagement score that characterizes a level of user engagement with respect to the second object. The engagement score characterizes extent to which the user is focused on the second object. For example, in some implementations, the portion of the method 500 represented by block 514 is similar to the portion of the method 400 represented by block 412.

As represented by block 516, the method 500 includes determining that the finger-wearable device performs the second gesture based on a function of the finger manipulation data. For example, in some implementations, the portion of the method 500 represented by block 516 is similar to the portion of the method 400 represented by block 418.

As represented by block 518, in response to determining that the finger-wearable device performs the second gesture, the method 500 includes determining whether or not the engagement score satisfies an engagement criterion. For example, in some implementations, the portion of the method 500 represented by block 518 is similar to the portion of the method 400 represented by block 420.

In response to determining that the engagement score satisfies the engagement criterion, the method 500 proceeds to a portion of the method 500 represented by block 520. As represented by block 520, the method 500 includes displaying, on the display, an indication indicating that the second gesture is directed to the second object. For example, in some implementations, the portion of the method 500 represented by block 520 is similar to the portion of the method 400 represented by block 422.

On the other hand, in response to determining that the engagement score does not satisfy the engagement criterion, the method 500 foregoes displaying an indication and reverts to the portion of the method 500 represented by block 516. For example, in some implementations, reverting to the portion of the method 500 represented by block 516 is similar to reverting to the portion of the method 400 represented by block 418.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user's personal information. For example, such personal information may be utilized in order to provide an improved privacy screen on an electronic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at an electronic device with one or more processors, a non-transitory memory, a display, and a communication interface provided to communicate with a finger-wearable device:
displaying, on the display, first instructional content that is associated with a first gesture, wherein the first instructional content includes a first object;
obtaining finger manipulation data from the finger-wearable device via the communication interface;
determining an engagement score that characterizes a level of user engagement with respect to the first object;
determining that the finger-wearable device performs the first gesture based on a function of the finger manipulation data; and
in response to determining that the finger-wearable device performs the first gesture:
in accordance with a determination that the engagement score satisfies an engagement criterion, displaying, on the display, an indication indicating that the first gesture is directed to the first object.

2. The method of claim 1, wherein the finger manipulation data includes positional data, the method further comprising:
identifying a respective location that corresponds to the finger-wearable device based on a function of the positional data; and
determining that the engagement score satisfies the engagement criterion based on the respective location satisfying a proximity threshold with respect to the first object.

3. The method of claim 2, further comprising, in response to determining that the respective location satisfies the proximity threshold with respect to the first object, setting a user handedness value based on a function of the finger manipulation data.

4. The method of claim 3, wherein the electronic device includes an extremity tracking system that outputs extremity tracking data, wherein the extremity tracking data is indicative of one or more locations that respectively correspond to one or more user extremities, and wherein setting the user handedness value is based on a comparison between the respective location that corresponds to the finger-wearable device and the one or more locations that respectively correspond to the one or more user extremities.

5. The method of claim 1, wherein the electronic device includes a first input device, the method further comprising:
receiving an untethered input via the first input device; and
determining that the engagement score satisfies the engagement criterion based on the untethered input.

6. The method of claim 5, further comprising identifying a first location based on a function of the untethered input, wherein determining that the engagement score satisfies the engagement criterion is based on the first location satisfying a proximity threshold with respect to the first object.

7. The method of claim 1, wherein the finger-wearable device is not viewable on the display.

8. The method of claim 1, wherein the first instructional content includes a representation of the finger-wearable device, and wherein the representation of the finger-wearable device is based on the finger manipulation data.

9. The method of claim 1, further comprising:
detecting that the finger-wearable device is proximate to the electronic device; and
in response to detecting that the finger-wearable device is proximate to the electronic device, pairing the electronic device with the finger-wearable device and displaying the first instructional content.

10. The method of claim 1, wherein the finger manipulation data includes sensor data associated with one or more sensors integrated in the finger-wearable device.

11. The method of claim 10, wherein the sensor data includes positional data output from one or more positional sensors integrated in the finger-wearable device.

12. The method of claim 10, wherein the sensor data includes contact intensity data output from a contact intensity sensor integrated in the finger-wearable device.

13. The method of claim 1, further comprising:
detecting a gesture change request associated with a second gesture; and
in response to detecting the gesture change request, replacing the first instructional content with second instructional content, wherein the second instructional content is associated with a second gesture that is different from the first gesture, and wherein the second instructional content includes a second object.

14. The method of claim 13, wherein detecting the gesture change request is based on a function of the finger manipulation data.

15. The method of claim 1, further comprising:
obtaining, from the finger-wearable device via the communication interface, status information associated with the finger-wearable device; and
in response to obtaining the status information, displaying, on the display, a status indicator indicating the status information associated with the finger-wearable device.

16. The method of claim 15, wherein the status indicator indicates a battery life associated with the finger-wearable device.

17. The method of claim 1, wherein the electronic device corresponds to a head-mountable device (HMD).

18. The method of claim 1, further comprising, in response to determining that the finger-wearable device performs the first gesture:
in accordance with a determination that the engagement score does not satisfy the engagement criterion, foregoing displaying the indication.

19. An electronic device comprising:
one or more processors;
a non-transitory memory;
a display;
a communication interface provided to communicate with a finger-wearable device; and
one or more programs, wherein the one or more programs are stored in the non-transitory memory and configured to be executed by the one or more processors, the one or more programs including instructions for:
displaying, on the display, first instructional content that is associated with a first gesture, wherein the first instructional content includes a first object;
obtaining finger manipulation data from the finger-wearable device via the communication interface;
determining an engagement score that characterizes a level of user engagement with respect to the first object;
determining that the finger-wearable device performs the first gesture based on a function of the finger manipulation data; and
in response to determining that the finger-wearable device performs the first gesture:
in accordance with a determination that the engagement score satisfies an engagement criterion, displaying, on the display, an indication indicating that the first gesture is directed to the first object.

20. A non-transitory computer readable storage medium storing one or more programs, the one or more programs comprising instructions, which, when executed by an electronic device with one or more processors, a display, and a communication interface provided to communicate with a finger-wearable device, cause the electronic device to:
display, on the display, first instructional content that is associated with a first gesture, wherein the first instructional content includes a first object;
obtain finger manipulation data from the finger-wearable device via the communication interface;
determine an engagement score that characterizes a level of user engagement with respect to the first object;
determine that the finger-wearable device performs the first gesture based on a function of the finger manipulation data; and
in response to determining that the finger-wearable device performs the first gesture:
in accordance with a determination that the engagement score satisfies an engagement criterion, display, on the display, an indication indicating that the first gesture is directed to the first object.
